(19) United States
(12) Patent Application Publication
(10) Pub. No.: US 2010/0332631 A1
(43) Pub. Date: Dec. 30, 2010

(54) COMMUNICATION APPARATUS, ADDRESS SETTING METHOD, AND ADDRESS SETTING PROGRAM

(75) Inventors: Shigeki SEKINE, Kawasaki (JP); Fumihiro Sakurai, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/774,271

(22) Filed: May 5, 2010

(30) Foreign Application Priority Data
Jun. 30, 2009 (JP) 2009-156346

(51) Int. Cl. G06F 15/177

(52) U.S. Cl. 709/222

(57) ABSTRACT

A communication device includes a packet acquirer configured to acquire a packet from a network interface, an address solution request-detector configured to detect an address solution request packet from the acquired packet, and an address setter configured to set a network address specified based on the address solution request packet as a network address of an own device.

### CROSS-REFERENCE TO RELATED APPLICATIONS

This application is based upon and claims the benefit of priority of the prior Japanese Patent Application No. 2009-156346, filed on Jun. 30, 2009, the entire contents of which are incorporated herein by reference.

### FIELD

The embodiments discussed herein are related to a communication device, an address setting method, and an address setting program.

### BACKGROUND

In the past, when connecting two devices to each other through Internet Protocol (IP) for the sake of testing, etc., an IP address has been set to each of the devices. When setting the IP addresses, network settings are made through the use of standard commands provided for an operating system (OS). Thus, the host address of the party at the other end is determined in consideration of subnets to establish a direct connection between the two devices, and items useful to perform communications, such as the IP address, a subnet mask, and so forth, are set for each of the devices to confirm communications performed between the devices.

Further, the method of providing a Dynamic Host Configuration Protocol (DHCP) server and assigning an address of a specified range to each of clients through the DHCP so that the address is set to each of devices has often been used. Since the DHCP server is provided at the connection destination, the connection source may perform communication without being concerned with the address of the party at the other end.

The technology for setting an address through the use of an Internet control message protocol (ICMP) echo request issued in response to a packet Internet grouper (ping) command transmitted when the ICMP is used has been devised as a different technology.

According to the method of setting the IP address for each of two devices, however, operations are performed between the two devices to set the IP address for each of the two devices. For example, when a testing device is temporarily connected to each of many devices-targeted-for-testing, the IP address setting is performed as many times as the number of the devices-targeted-for-testing so that an increase in the number of operation hours and/or man-hours becomes burdensome for establishing the device connection.

When the DHCP environment is provided, it becomes possible to establish the connection without concern for the network information of the party at the other end. However, when the DHCP server is installed in the device to increase the connection convenience in the case where a closed network including the two devices are temporarily provided, as in the case where the above-described testing is performed, the man-hours that are spent in installing the DHCP server for establishing the device connection become burdensome, and communications should be performed in consideration of the IP address of the party at the other end, the IP address being assigned through the use of the DHCP.

Further, known technologies performed to set an address through the ICMP echo request have been devised for a general purpose network and have been necessarily provided with functions performed through the use of the ICMP, such as the ping command. Still further, a media access control (MAC) address has been necessarily specified according to the above-described technologies.

Thus, the above-described known technologies have been devised mainly for providing a condition under which many communication devices can communicate with one another. Namely, according to the above-described known technologies, it has been difficult to connect two communication devices to each other with facility.

### SUMMARY OF THE INVENTION

According to an aspect of the embodiments, a communication device including a packet acquirer configured to acquire a packet from a network interface, an address solution request-detector configured to detect an address solution request packet from the acquired packet, and an address setter configured to set a network address specified based on the address solution request packet as a network address of an own device.

The object and advantages of the various embodiments will be realized and attained by means of the elements and combinations particularly pointed out in the claims.

It is to be understood that both the foregoing general description and the following detailed description are exemplary and explanatory and are not restrictive of the various embodiments, as claimed.

The above-described embodiments of the present invention are intended as examples, and all embodiments of the present invention are not limited to including the features described above.

### BRIEF DESCRIPTION OF THE DRAWINGS

FIG. 1 illustrates a device-targeted-for-testing provided as a communication device according to a first embodiment;

FIG. 2 illustrates an address resolution protocol (ARP) used in the device-targeted-for-testing;

FIG. 3 illustrates an ARP used in a device-targeted-for-testing exemplarily compared to the device-targeted-for-testing;

FIG. 4 illustrates a configuration where the channel extension devices of a server are connected to a testing device;

FIG. 5 is a flowchart illustrating processing operations performed through the device-targeted-for-testing;

FIG. 6 illustrates the configuration of a communication device according to a second embodiment; and

FIG. 7 illustrates an exemplary configuration where a testing device illustrated in FIG. 6 is used to test channel extension devices that are illustrated in the first embodiment.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

Hereinafter, an embodiment of a communication device, an address setting method, and an address setting program will be described in detail with reference to the attached drawings. Technologies are not limited to the embodiment described below.

### First Embodiment

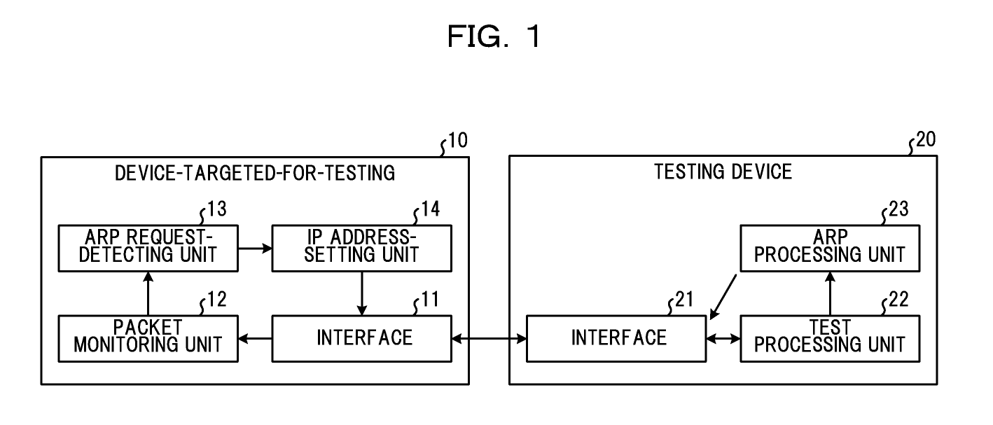

FIG. 1 illustrates a device-targeted-for-testing 10 provided as a communication device according to a first embodiment. The device-targeted-for-testing 10 may be an arbitrary device so long as a communication function is provided therefor. The device-targeted-for-testing 10 includes an interface 11, a packet monitoring unit 12, an ARP (address resolution protocol) request-detector 13, and an IP address-setter 14.

The interface 11 is connected to an interface 21 of a testing device 20 provided to test the device-targeted-for-testing 10. In addition to the interface 21, the testing device 20 includes an ARP processor 23 and a test processor 22.

ARP is a protocol used to obtain a MAC address from an IP address in an Ethernet (a registered trademark) environment. The address of a lower data link layer should be acquired to transmit and/or receive an IP packet through the use of Transmission Control Protocol/Internet Protocol (TCP/IP). ARP is used when using the MAC address as the address of the lower data link layer.

More specifically, information about the IP address and MAC address of the transmission source and the IP address of the transmission destination is stored in an ARP request packet, and the ARP request packet is broadcast to an Ethernet network. Upon receiving the ARP request packet, each of nodes informs the transmission source of own MAC address as an ARP response packet when the IP address of the transmission destination is the same as own IP address, where information about the IP address of the transmission destination is included in the ARP request packet. Thus, the MAC address is acquired from the IP address.

In the testing device 20, the ARP processor 23 transmits the ARP request packet via the interface 21. Upon receiving an ARP response transmitted from the device-targeted-for-testing 10, the ARP processor 23 performs the remainder of the communication based on the MAC address information transmitted from the device-targeted-for-testing 10.

The test processor 22 communicates with the device-targeted-for-testing 10 via the interface 21 to test the operations of the device-targeted-for-testing 10, monitor the operation state of the device-targeted-for-testing 10, etc. During the communications with the test processor 22, the MAC address acquired through the ARP processor 23 by using ARP is used.

The packet monitoring unit 12 of the device-targeted-for-testing 10 monitors a packet transmitted to the interface 11 through a tcpdump, etc. The packet monitoring unit 12 transmits data output from the tcpdump to the ARP request-detector 13.

The ARP request-detector 13 detects an ARP request from the packet transmitted to the interface 11 of the device-targeted-for-testing 10. The ARP request-detector 13 reads an IP address specified in the ARP request packet and notifies the IP address-setter 14 of the read IP address.

The IP address-setter 14 sets an IP address specified in ARP request as the IP address of the device-targeted-for-testing 10 through the use of an ipconfig, etc.

Therefore, the device-targeted-for-testing 10 determines any IP address specified in the ARP request to be own IP address, and transmits an ARP response to the testing device 20.

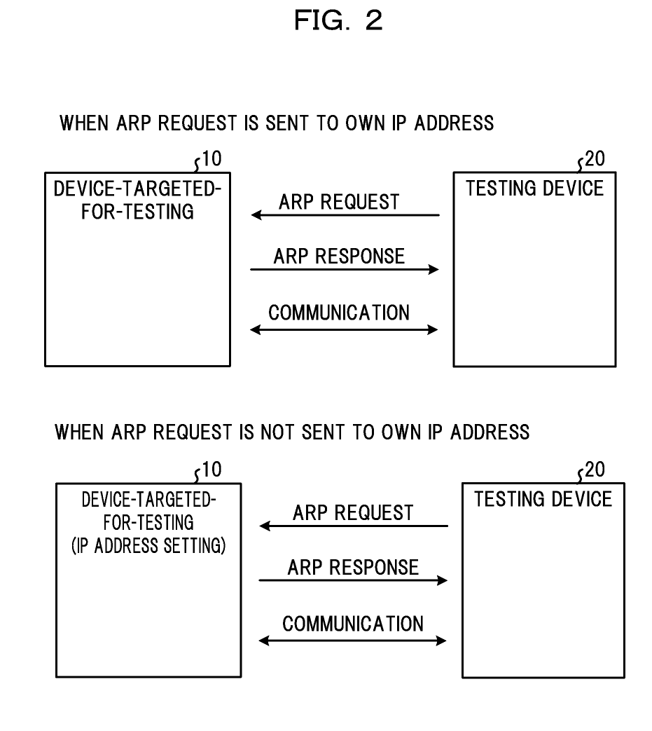

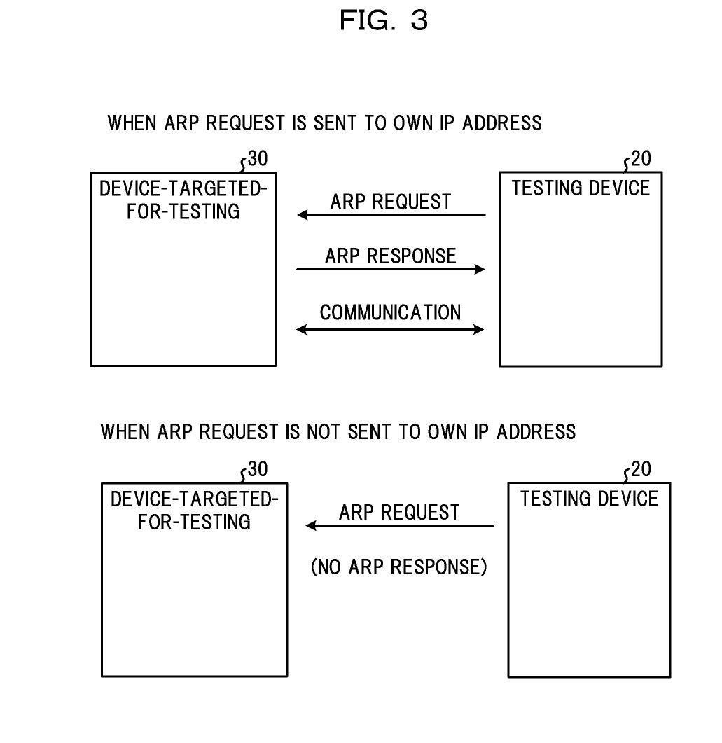

FIG. 2 illustrates ARP used in the device-targeted-for-testing 10. Further, FIG. 3 illustrates ARP used in a device-targeted-for-testing 30 exemplarily compared to the device-targeted-for-testing 10 of the embodiment.

When the IP address of the device-targeted-for-testing 10 is specified in the ARP request transmitted from the testing device 20 to the device-targeted-for-testing 10 as illustrated in FIG. 2, namely, when the ARP request is sent to own IP address, the device-targeted-for-testing 10 transmits an ARP response as usual and starts communication.

Further, when an IP address different from that of the device-targeted-for-testing 10 is specified in the ARP request transmitted from the testing device 20 to the device-targeted-for-testing 10, in other words, when the ARP request is not sent to own IP address, the device-targeted-for-testing 10 sets the IP address specified in the ARP request as its own address and transmits the ARP response. Consequently, it becomes possible to start communication as in the case where the IP address of the device-targeted-for-testing 10 is specified in the IP address of the ARP request.

Further, when time-out processing is performed for the ARP request transmitted from the testing device 20, the testing device 20 retransmits the ARP request. When re-transmitting the ARP request, the IP address for which the testing device 20 had issued the request is set as the IP address of the device-targeted-for-testing 10. From then on, therefore, an ordinary IP sequence is performed so that the IP-level communication between the testing device 20 and the device-targeted-for-testing 10 is performed.

Therefore, the IP address specified through the testing device 20 based on the ARP request may be an arbitrary address. Further, the IP address information that had once been set to the device-targeted-for-testing 10 is stored on software as a cache.

On the other hand, according to the example illustrated in FIG. 3, the device-targeted-for-testing 30 transmits an ARP response as usual and starts communication when the IP address of the device-targeted-for-testing 30 is specified in the ARP request transmitted from the testing device 20 to the device-targeted-for-testing 30.

However, when an IP address different from that of the device-targeted-for-testing 30 is specified in the ARP request transmitted from the testing device 20, in other words, when the ARP request is not sent to own IP address, the device-targeted-for-testing 30 does not transmit the ARP response. Therefore, the remainder of the communication cannot be performed.

Thus, in the above-described embodiment, the device-targeted-for testing transmits own Ethernet address in response to an ARP request issued for every IP address for connecting two devices to each other through the mechanism of the tcpdump and the ARP. Namely, since the IP address specified in the ARP request is set as own IP address and an ARP response is transmitted, the network connection between two devices can be established without making complicated IP address settings.

The above-described advantages become significant when a closed network is structured for each of different combinations of two devices.

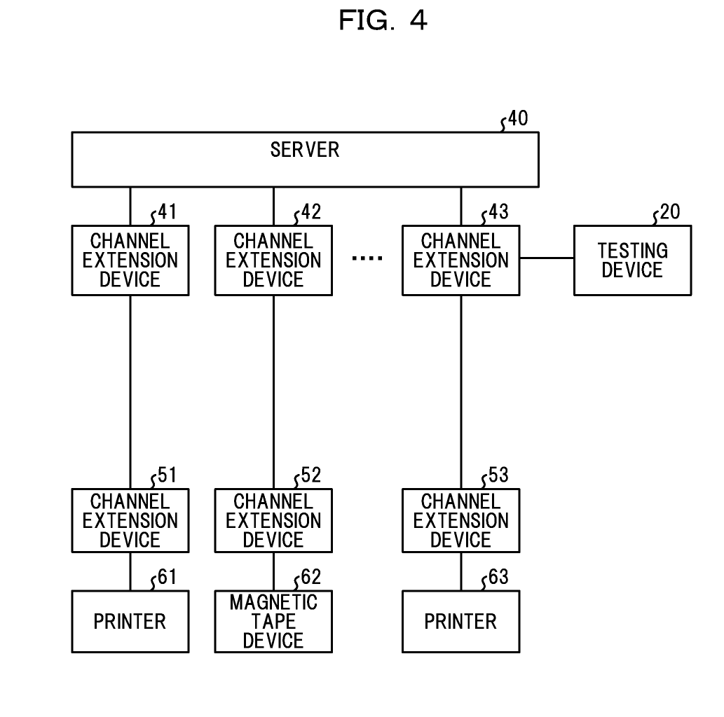

FIG. 4 illustrates a configuration where the channel extension devices of a server are connected to the testing device 20. According to the configuration illustrated in FIG. 4, channel extension devices 41, 42, and 43 are connected to a server 40. Each of the channel extension devices 41 to 43 is provided to extend a communicable distance of the server 40. When an input-and-output device including a printer, a magnetic tape device, etc. is directly connected to the server 40, the length of a cable connecting the server 40 to the input-and-output device would be a few hundred meters or around at the maximum. However, if the channel extension device is placed between the server 40 and the input-and-output device, the length of the cable connecting the server 40 to the input-and-output device is not limited.

According to the configuration illustrated in FIG. 4, the channel extension device 41 is connected to a channel extension device 51 via a network and the channel extension device 51 is connected to a printer 61 provided as the input-and-output device. Likewise, the channel extension device 42 is connected to a channel extension device 52 via the network, and the channel extension device 52 is connected to a magnetic tape device 62 provided as the input-and-output device. Further, the channel extension device 43 is connected to a channel extension device 53 via the network, and the channel extension device 53 is connected to a printer 63 provided as the input-and-output device.

Each of the channel extension devices 41 to 43 includes a maintenance interface in addition to an interface provided so that the channel extension devices 41 to 43 are connected to the individual channel extension devices 51 to 53 therethrough. Likewise, each of the channel extension devices 51 to 53 includes a maintenance interface in addition to an interface provided so that the channel extension devices 51 to 53 are connected to the individual channel extension devices 41 to 43 therethrough.

The testing device 20 is connected to the maintenance interfaces of the channel extension devices 41 to 43 and/or to the channel extension devices 51 to 53 so that the testing device 20 operates the operation test and/or monitors the operation state of each of the channel extension devices 41 to 43 and/or the channel extension devices 51 to 53.

The connection between the testing device 20 and the channel extension devices 41 to 43 and/or the channel extension devices 51 to 53 is temporarily established to test and/or monitor the above-described channel extension devices. The testing device 20 is connected, for testing and/or monitoring, to the channel extension devices 41 to 43 and/or the channel extension devices 51 to 53 on a one-to-one basis, and is reconnected to a different connection destination, that is, the channel extension devices in sequence. Consequently, the testing device 20 can test and/or monitor each of the channel extension devices.

Thus, when communication is performed between two devices while changing the connection destination of the testing device 20 to a different connection destination, the advantage of testing and/or a reduction effect on man-hours spent in monitoring is increased by simplifying the IP address settings.

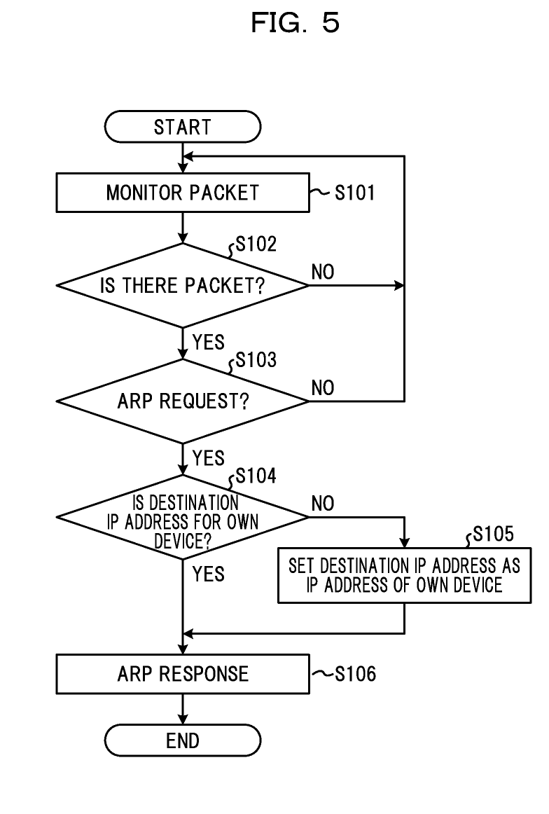

FIG. 5 is a flowchart illustrating processing operations performed through the device-targeted-for-testing 10. As illustrated in FIG. 5, the packet monitoring unit 12 of the device-targeted-for-testing 10 monitors packets that are transmitted to the interface 11 (S101). When any packet is transmitted to the packet monitoring unit 12 (when the answer is Yes at S102), the ARP request-detector 13 determines whether or not the transmitted packet is a packet including an ARP request (S103).

When an ARP request is not included in the transmitted packet (when the answer is No at S103), the device-targeted-for-testing 10 returns to monitor the packets (S101).

When the transmitted packet includes an ARP request (when the answer is Yes at S103), the device-targeted-for-testing 10 determines whether or not the IP address of a destination indicated by the ARP request is the IP address of the own device (S104). If the determination result illustrates that the IP address of the destination is the address of the own device (when the answer is Yes at S104), the device-targeted-for-testing 10 returns the ARP response to the testing device, as it is (S106), and finishes the address setting.

On the other hand, when the IP address of the destination indicated by the ARP request is not the IP address of the own device (when the answer is No at S104), the IP address-setter 14 sets the IP address of the destination indicated by the ARP request as the IP address of the own device (S105). Consequently, the destination address of the ARP request agrees with the IP address of the own device. Therefore, the device-targeted-for-testing 10 returns the ARP response to the testing device (S106) and finishes the address setting.

Thus, the first embodiment allows for connecting devices to each other without concern for the IP address of the party at the other end in a closed IP network including two devices, that is to say, between devices that are directly connected to each other. Therefore, connection settings made in consideration of subnets of each other may be eliminated and the two devices may be connected to each other based on the IP addresses of arbitrary desirable destinations. Further, the DHCP server and the clients may not be prepared only for connecting the two devices to each other. Here, the above-described address setting may be performed through an arbitrary protocol attained by using the IP.

### Second Embodiment

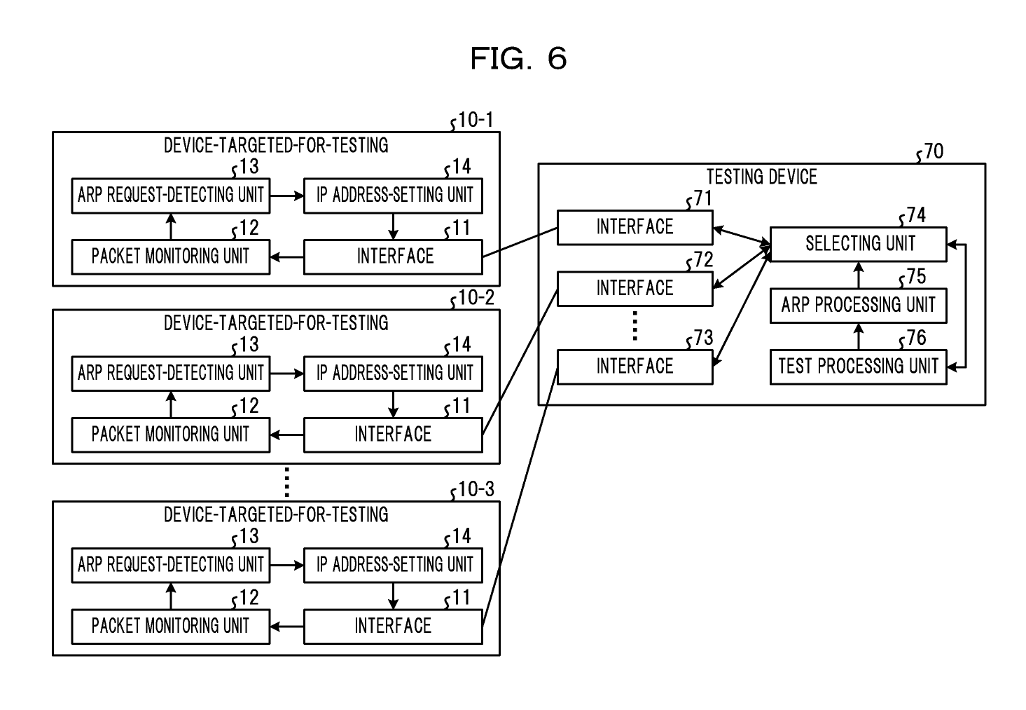

FIG. 6 illustrates the configuration of a communication device according to a second embodiment. According to the above-described configuration, a plurality of devices-targeted-for-testing 10-1, 10-2, and 10-3 is connected to a testing device 70. Since the configuration and operations of each of the devices-targeted-for-testing 10-1 to 10-3 are the same as those of the device-targeted-for-testing 10 of the first embodiment, the same components as those of the device-targeted-for-testing 10 are designated by the same reference numerals and the descriptions thereof are omitted.

The testing device 70 includes interfaces 71, 72, and 73, a selector 74, an ARP processor 75, and a test processor 76.

The interfaces 71 to 73 are connected to the individual devices-targeted-for-testing 10-1 to 10-3 on a one-to-one basis. The selector 74 is a switch provided to select any one of the interfaces 71 to 73. The ARP processor 75 and the test processor 76 perform the same operations for the selected interface as those performed by the ARP processor 23 and the test processor 22 that are clarified in the first embodiment.

Thus, the plurality of interfaces is provided in the testing device 70 and the interfaces and the devices-targeted-for-testing are connected to one another on a one-to-one basis while being switched over to one another for use. Consequently, the IP address setting performed between the devices-targeted-for-testing and the testing device 70 can be performed as is the case with the first embodiment.

Further, if there is an overlap among the IP addresses of the devices-targeted-for-testing 10-1 to 10-3, the communication destination of the test processor 76 can be recognized through the recognition of the interfaces 71 to 73. Therefore, testing and monitoring can be performed in parallel with each other for the devices-targeted-for-testing 10-1 to 10-3.

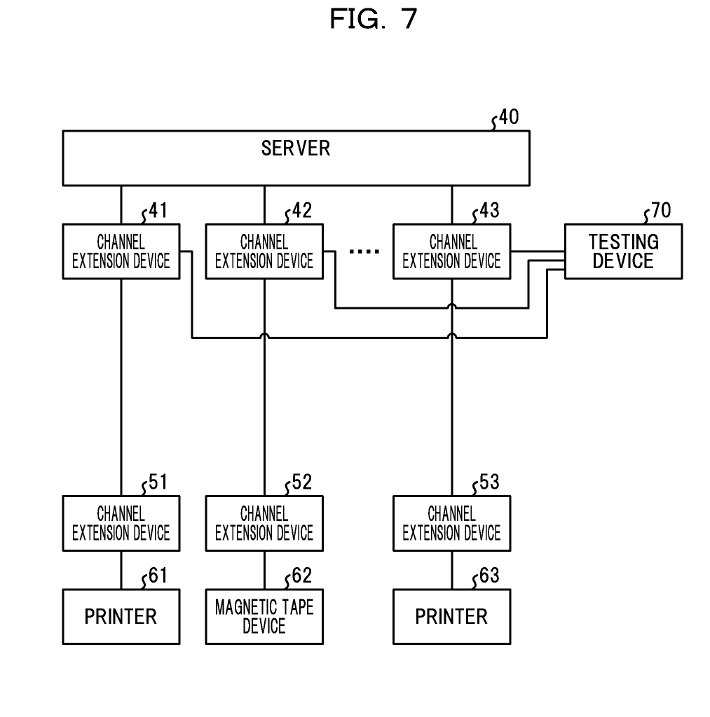

FIG. 7 illustrates an exemplary configuration where the testing device 70 illustrated in FIG. 6 is used to test the channel extension devices 41 to 43 that are illustrated in the first embodiment. The testing device 70 is connected to the channel extension devices 41 to 43 at one time so that the testing device 70, which is connected to the channel extension devices at one time, can be easily switched from one of the channel extension devices to another of the channel extension devices.

As described above, the second embodiment allows for connecting the testing device to the devices-targeted-for-testing on a one-to-one basis and setting the IP address of each of the devices-targeted-for-testing with facility.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A communication device comprising:
a packet acquirer configured to acquire a packet from a network interface;
an address solution request-detector configured to detect an address solution request packet from the acquired packet; and
an address setter configured to set a network address specified based on the address solution request packet as a network address of an own device.

2. The communication device according to claim 1, further comprising:
a network interface used when a normal operation is performed and a network interface used when a test is performed,
wherein the packet acquirer acquires the packet from the network interface used when the test is performed.

3. A communication device comprising:
a plurality of network interfaces;
a selector configured to select any one of the network interfaces; and
an address solution processor configured to transmit an address solution request packet via the selected network interface.

4. The communication device according to claim 3, further comprising:
a test processor configured to perform a test for a device connected to the selected network interface via the selected network interface.

5. A method for setting an address of a communication device comprising:
acquiring a packet from a network interface;
detecting an address solution request packet from the acquired packet; and
setting a network address specified based on the address solution request packet as a network address of an own device.

6. A computer-readable recording medium storing an address setting program, the address setting program causes the communication device to execute:
acquiring a packet from a network interface;
detecting an address solution request packet from the acquired packet; and
setting a network address specified based on the address solution request packet as a network address of an own device.
